(19) United States
(12) Patent Application Publication
(10) Pub. No.: US 2024/0288998 A1
(43) Pub. Date: Aug. 29, 2024

(54) INFORMATION PROCESSING DEVICE AND COMPUTER PROGRAM

(71) Applicant: Faurecia Clarion Electronics Co., Ltd., Saitama-shi (JP)

(72) Inventor: Hiroe USHIO, Saitama-shi (JP)

(73) Assignee: Faurecia Clarion Electronics Co., Ltd., Saitama-shi (JP)

(21) Appl. No.: 18/584,128

(22) Filed: Feb. 22, 2024

(30) Foreign Application Priority Data
Feb. 27, 2023 (JP) 2023-028848

(51) Int. Cl. G06F 3/0484; G06F 3/0481; G06F 3/14

(52) U.S. Cl. CPC G06F 3/0484; G06F 3/0481; G06F 3/1454

(57) ABSTRACT

The information processing device receives a first operation request from a user via a user interface or a second operation request from an external terminal via a communication interface, and when the first operation request is received, the information processing device executes an operation restriction based on the restriction information, and when a second operation request is received, the information processing device executes an operation restriction based on the requesting external terminal and the restriction information.

### FIELD OF THE INVENTION

The present invention relates to information processing.

### BACKGROUND ART

An information processing device (for example, an in-vehicle device) having a communication interface that is connected to an external terminal and a user interface that accepts operation requests from the user is known. This type of information processing device accepts both operation requests from the user via the user interface and from an external terminal (for example, a mobile terminal of a passenger in the vehicle) via the communication interface. For example, according to the technology disclosed in Patent Document 1, operation input and/or screen output from a sub portable communication terminal 13 is enabled for content that is prohibited for use from both the main portable communication terminal 12, which is assumed to be owned by the driver, and the vehicle communication device 11.

### PRIOR ART DOCUMENTS

### Patent Documents

Patent Document 1: Japanese Unexamined Patent Application 2013-219659

### SUMMARY OF THE INVENTION

### Problem to be Solved by the Invention

One issue with these information processing devices is that functions that are not desired to be operated by anyone other than the driver (for example, wiper operation) can be operated from an external terminal.

Therefore, an object of the present invention is to apply flexible operation restrictions according to the situation to operations on the information processing device itself and to operations from external terminals.

### Means for Solving the Problem

A typical information processing device of the present invention receives either a first operation request, which is an operation request from the user via the user interface, or a second operation request, which is an operation request from an external terminal via the communication interface, in order to achieve the aforementioned object. If the received operation request is a second operation request, the information processing device identifies the external terminal that is the request source of the second operation request, based on the second operation request. The information processing device executes the operation restriction based on the restriction information when a first operation request is received, and executes the operation restriction based on the identification result of the external terminal identifying unit and the restriction information, when a second operation request is received.

### Effect of the Invention

The present invention is to apply flexible operation restrictions according to the situation to operations on the information processing device itself and to operations from external terminals. The following description of the embodiments will elucidate the problems, configurations, and effects other than those described above.

### BRIEF DESCRIPTION OF THE DRAWINGS

FIG. 1 is a schematic diagram of an information processing device according to the present embodiment.

FIG. 2 is a configuration diagram of the operation restriction information.

FIG. 3A is a schematic diagram of the Mirroring mode.

FIG. 3B is a schematic diagram of the Extension mode.

FIG. 4 is a flowchart depicting the flow of operations of the information processing device.

FIG. 5 a flowchart depicting determining whether or not a travel restriction is required (S4 in FIG. 4).

FIG. 6 a flowchart depicting determination of need for restriction (S10 in FIG. 4).

### EMBODIMENTS OF THE INVENTION

An embodiment of the present invention is described below with reference to the figures. In the following description, a common symbol may be used in the reference symbols when the same type of element is described without distinction, and reference symbols may be used to distinguish the same type of element.

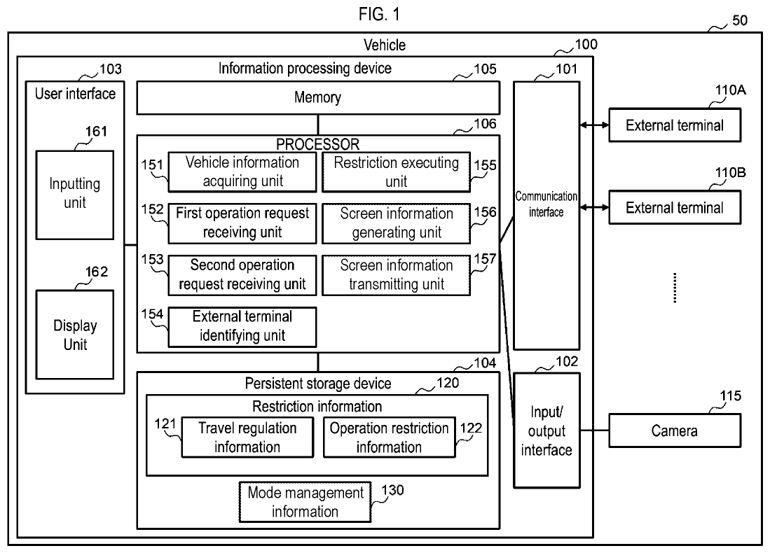

FIG. 1 is a schematic diagram of an information processing device according to the present embodiment.

An information processing device 100 is installed in a vehicle 50. The information processing device 100 is typically an in-vehicle device, but may be a device other than an in-vehicle device.

The information processing device 100 has a communication interface 101, an input/output interface 102, a user interface 103, a persistent storage device 104, memory 105, and a processor 106 connected thereto. One or both of the persistent storage device 104 and the memory 105 are examples of storage units.

The communication interface 101 is a device that communicates wirelessly with the external terminal 110. The “external terminal” is an information processing terminal (typically a mobile terminal) external to the information processing device 100, for example, a smartphone or tablet terminal. For example, the information processing device 100 functions as an access point, and wireless communication may be 1-to-many communication (for example, WiFi (registered trademark)), but the wireless communication may also be 1-to-1 communication.

The input/output interface 102 is a device that communicates with vehicle-mounted equipment other than the information processing device 100 and the external terminal 110. Vehicle-mounted equipment includes, for example, a camera 115 that captures images inside the vehicle 50.

The user interface 103 is a device with an input unit 161 and a display unit 162. The input unit 161 accepts user operations (for example, click operations and flick operations). The display unit 162 displays a screen or the like. The user interface 103 can be a touch panel display.

The persistent storage device 104 is typically a non-volatile storage device (for example, auxiliary storage device), and specific examples include a hard disk drive (HDD) or solid-state drive (SSD). Restriction information 120 and mode management information 130 are stored in the persistent storage device 104.

Restriction information 120 is information for applying restrictions to functions performed by the information processing device 100 in response to a first operation request or second operation request described below. Restriction information 120 includes travel restriction information 121 and operation restriction information 122. The travel restriction information 121 is an example of the first restriction information and is information for applying operation restrictions to the functions of the information processing device 100 when the vehicle is in motion. The operation restriction information 122 is an example of the second restriction information and is information for applying operation restrictions to operations from an external terminal 110. The mode management information 130 is information indicating whether the current screen providing mode is Mirroring mode (an example of the first mode) or Extension mode (an example of the second mode).

The memory 105 is typically volatile memory, but may include nonvolatile memory. A computer program is read from a program source and stored in the memory 105. The program source may be a server, persistent storage device 104, or a readable storage medium (for example, non-transient storage medium).

The processor 106 is one or more processor devices. Processor devices are typically microprocessor devices such as a CPU (Central Processing Unit), but may also be other types of processor devices such as a GPU (Graphics Processing Unit). The processor device can also be a processor device in the broad sense of the term, such as a hardware circuit that performs a portion or all of the processing (for example, a Field-Programmable Gate Array (FPGA) or Application Specific Integrated Circuit (ASIC). When the processor 106 executes a computer program in the memory 105, the functions of a vehicle information acquiring unit 151, first operation request receiving unit 152, second operation request receiving unit 153, external terminal identifying unit 154, restriction executing unit 155, screen information generating unit 156, and screen information transmitting unit 157 are realized. The following functions are achieved. These functions 151 to 155 are examples, and a plurality of functions may be combined into one function, or one function may be split into a plurality of functions.

The vehicle information acquiring unit 151 acquires vehicle information including vehicle speed information. The first operation request receiving unit 152 receives a first operation request which is an operation requested received from the user via the user interface 103. The second operation request receiving unit 153 receives a second operation request which is an operation request received from the external terminal 110 via the communication interface 101. If the received operation request is a second operation request, the external terminal identifying unit 154 identifies the external terminal 110 that is the request source of the second operation request. The restriction executing unit 155 executes the operation restriction based on the restriction information 120 when a first operation request is received, and executes the operation restriction based on the identification results (in other words, that the identified external terminal 110 is one of the external terminals 110) of the external terminal identifying unit 154 and the restriction information 120, when a second operation request is received. Thereby, flexible operation restrictions according to the situation can be applied to operations on the information processing device 100 itself and to operations from an external terminal 110.

The screen information generating unit 156 generates screen information for the screen displayed on the external terminal 110. The screen information transmitting unit 157 transmits the generated screen information to the external terminal 110.

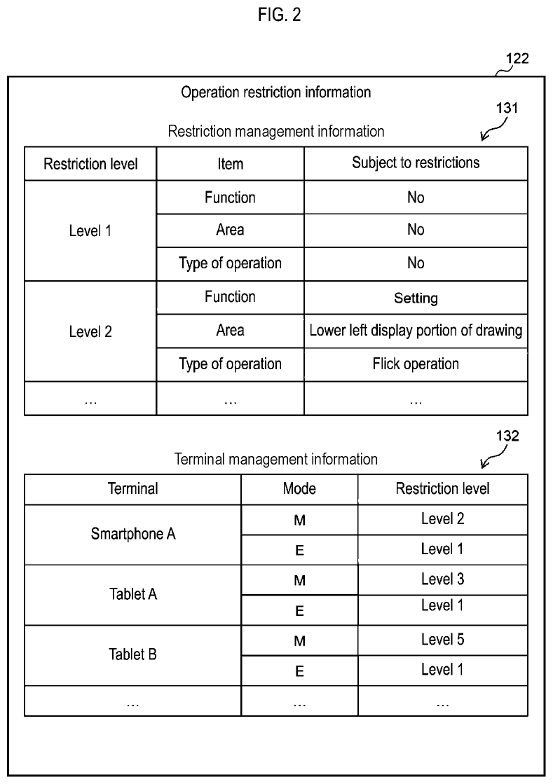

FIG. 2 is a configuration diagram of the operation restriction information 122.

The operation restriction information 122 includes restriction management information 131 and terminal management information 132.

Restriction management information 131 represents, for each restriction level, the restriction target based on that restriction level. The “restriction level” indicates the strength of the restriction, and a smaller number for the restriction level indicates a weaker restriction (lower restriction level). The items subject to restriction are “function” (functions to be performed), “area” (areas on a screen to be displayed), and “operation type” (type of operations to be performed on the screen). The “function” may be set for navigation, audio, or the like, in place of or in addition to Settings. The “operation type” may be set to slide, pinch in/out, long press, or the like, instead of or in addition to a flicking operation. Other items subject to restriction may be used in place of or in addition to at least one of these items.

The terminal management information 132 represents the restriction level of the operation restriction set for each external terminal 110 in a screen providing mode. Mode “M” means Mirroring mode, and Mode “E” means Extension mode.

The configuration of the operation restriction information 122 need not be limited to that depicted in FIG. 2. For example, there may be no concept of restriction levels, and the operation restriction information 122 may represent restriction details for each item subject to restriction based on the screen providing mode for each external terminal 110.

The operation restriction information 122 may correspond to Mirroring mode operation restriction information when the information is related to mode “M”, and may correspond to Extension mode operation restriction information when the information is related to mode “E”, for each external terminal 110. Furthermore, for each external terminal 110, one or a plurality of restriction levels may be associated with both mode “M” and mode “E”. Furthermore, for each external terminal 110, the same restriction level may be associated with both mode “M” and mode “E”.

Restrictions on operations from the external terminal 110 may be applied at all times or may vary depending on the function (for example, application) being performed in the information processing device 100. For example, the flick operations of the external terminal 110 may be set to disabled (not receivable) during navigation, but flick operations may be receivable during audio execution.

Only one of Mirroring mode and Extension mode may exist as the screen providing mode.

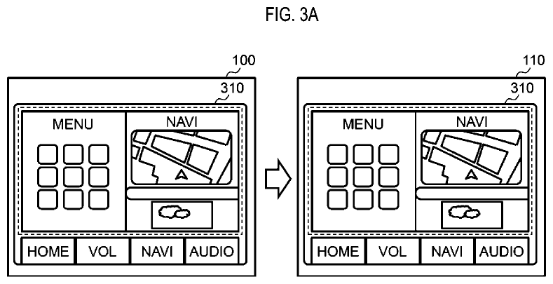

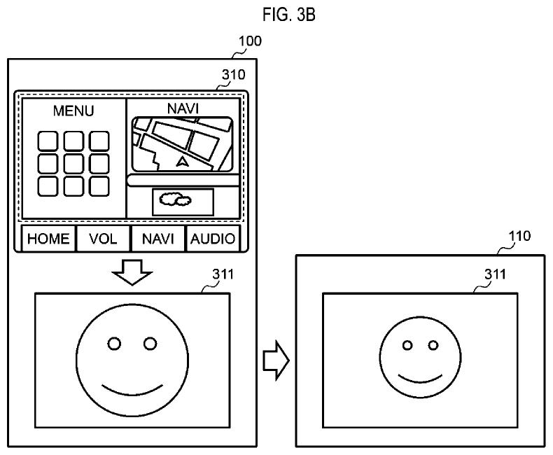

FIG. 3A is a schematic diagram of the Mirroring mode.

Mirroring mode is a mode that generates the same screen information on the screen 310 of the external terminal 110 as on the screen 310 displayed on the display unit 162. If the current screen providing mode is Mirroring mode, the screen information generating unit 156 generates the same screen information for the screen 310 displayed on the external terminal 110 as the screen information of the screen 310 displayed on the display unit 162. The screen information transmitting unit 157 transmits the generated screen information to the external terminal 110.

FIG. 3B is a schematic diagram of the Extension mode.

Extension mode is a mode that generates different screen information 311 on the external terminal 110 as on the screen 310 displayed on the display unit 162. If the current screen providing mode is Extension mode, the screen information generating unit 156 generates different screen information for the screen 311 displayed on the external terminal 110 than the screen information of the screen 310 displayed on the display unit 162. The screen information transmitting unit 157 transmits the generated screen information to the external terminal 110.

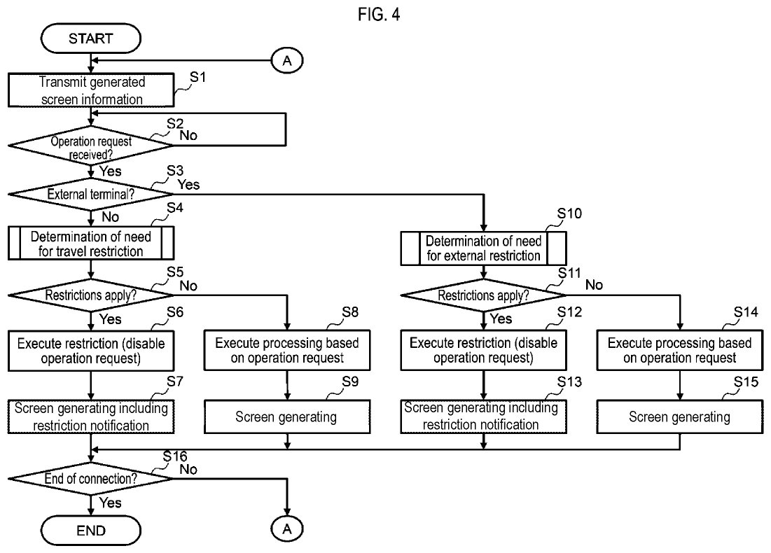

FIG. 4 is a flowchart showing the flow of operations of the information processing device 100.

In S1, a screen information transmitting unit 157 transmits the screen information generated for the external terminal 110 (or predetermined screen information) to the external terminal 110. The generation and transmission of screen information is performed based on the screen providing mode represented by the mode management information 130. The screen information transmitting unit 157 also displays on the display unit 162 the screen represented by the screen information generated for the display unit 162.

In S2, both the first operation request receiving unit 152 and the second operation request receiving unit 153 determine whether or not an operation request has been received.

If the determination result of S2 is true (S2: Yes) and if the operation request has been received by the first operation request receiving unit 152 (S3: No), the process proceeds to S4. If the operation request was received by the second operation request receiving unit 153 (S3: Yes), the process proceeds to S10.

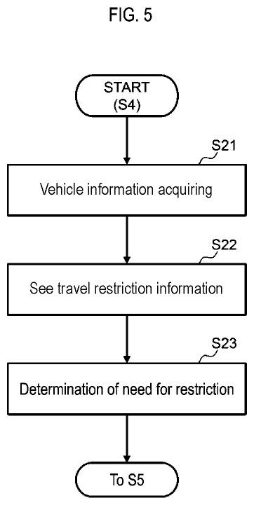

In S4, a determination of need for travel restriction (FIG. 5) is performed.

If the result of the determination of need for travel restriction is that a restriction is applicable (S5: Yes), the restriction executing unit 155 executes the restriction (disables the first operation request received by the first operation request receiving unit 152) in S6. In S7, the screen information generating unit 156 generates screen information for the screen to be displayed on the display unit 162 (including restriction notifications) and the screen to be displayed on the external terminal 110, based on the screen providing mode represented by the mode management information 130. If the connection is not terminated (S16: No), the process returns to S1. In other words, the generated screen information is transmitted. For example, a screen containing restriction notifications may be displayed in a pop-up on the screen displayed on the display unit 162. Regardless of the screen providing mode that is used, the screen containing the restriction notification is considered the top layer screen and that screen might not be provided to the external terminal 110.

If the result of the determination of need for travel restriction is that restrictions are not applicable (S5: No), the restriction executing unit 155 executes the process based on the first operation request in S8. In S9, the screen information generating unit 156 generates screen information for the screen to be displayed on the display unit 162 and the screen to be displayed on the external terminal 110, based on the screen providing mode represented by the mode management information 130. If the connection is not terminated (S16: No), the process returns to S1.

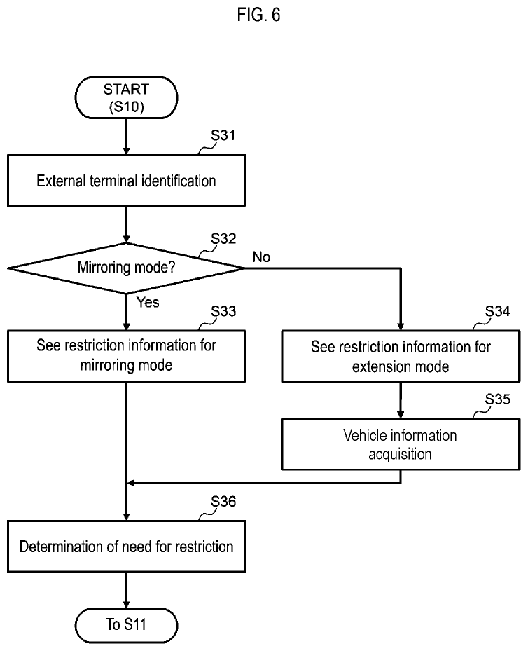

In S10, a determination of need for external restrictions (FIG. 6) is performed.

If the result of the determination of need for external restrictions is that a restriction is applicable (S11: Yes), the restriction executing unit 155 executes the restriction (disables the second operation request received by the second operation request receiving unit 153) in S12. In S13, the screen information generating unit 156 generates screen information for the screen to be displayed on the display unit 162 and the screen (including restriction notifications) to be displayed on the external terminal 110, based on the screen providing mode represented by the mode management information 130. If the connection is not terminated (S16: No), the process returns to S1. Note that S13 may be omitted.

If the result of the determination of need for travel restriction is that restrictions are not applicable (S11: No), the restriction executing unit 155 executes the process based on the second operation request in S13. In S15, the screen information generating unit 156 generates screen information for the screen to be displayed on the display unit 162 and the screen to be displayed on the external terminal 110, based on the screen providing mode represented by the mode management information 130. If the connection is not terminated (S16: No), the process returns to S1.

Regardless of whether the current screen providing mode is Mirroring mode or Extension mode, screen information for the screen containing the restriction notification may be generated at least for the display unit 162 in S7 of FIG. 4. This is to provide restriction notifications to the user who performed the operation.

Regardless of whether the current screen providing mode is Mirroring mode or Extension mode, screen information for the screen containing the restriction notification may be generated at least for the external terminal 110 which is the request source in S13 of FIG. 4. This is to provide a restriction notification to the user of the request source external terminal 110.

FIG. 5 a flowchart depicting determining whether or not a travel restriction is required (S4 in FIG. 4).

In S21, the vehicle information acquiring unit 151 acquires vehicle information including vehicle speed information (information representing vehicle speed). In S22, the restriction executing unit 155 refers to the travel restriction information 121.

In S23, the restriction executing unit 155 performs a determination of need for restriction, which is a determination of whether or not to disable the first operation request, based on the vehicle acquiring information obtained in S21 and the travel restriction information 121 referenced in S22. For example, the travel restriction information 121 may represent one or a plurality of operations that are restricted during travel. Each operation may be defined, for example, for each of one or a plurality of restricted items (for example, “function”, “area”, and “operation type” as depicted in FIG. 2). Furthermore, the operation of the restricted object may vary with vehicle speed. If the operation represented by the first operation request corresponds to an operation subject to restriction represented by the travel restriction information 121, the result of the determination of need for restriction in S23 is true (in other words, the result is that a restriction is applicable).

FIG. 6 a flowchart depicting determination of need for restriction (S10 in FIG. 4).

In S31, the external terminal identifying unit 154 identifies the external terminal 110 that is the request source of the second operation request based on the received second operation request. In S32, the restriction executing unit 155 refers to the mode management information 130 to determine whether the current screen providing mode is the Mirroring mode.

If the current screen providing mode is the Mirroring mode (S32: Yes), in S33, the restriction executing unit 155 refers to the operation restriction information 122 that corresponds to the external terminal 110 identified in S31 and to the information corresponding to the Mirroring mode. Furthermore, in S36, the restriction executing unit 155 performs a determination of need for restriction, which is a decision on whether or not to disable the second operation request. For example, if the operation represented by the second operation request conforms to the operation represented by the information referenced in S33, the result of the determination of need for restriction in S36 is true (or in other words, the result is that a restriction is applicable).

If the current screen providing mode is Extension mode (S32: No), in S34, the restriction executing unit 155 refers to the operation restriction information 122 that is the information corresponding to the external terminal 110 identified in S31 and the information corresponding to the Extension mode, and refers to the travel restriction information 121. Furthermore, in S35, the vehicle information acquiring unit 151 acquires vehicle information including vehicle speed information. Furthermore, in S36, the restriction executing unit 155 performs a determination of need for restriction, which is a decision on whether or not to disable the second operation request. For example, if the operation represented by the second operation request conforms to the operation represented by the information referenced in S33, the result of the determination of need for restriction in S36 is true (or in other words, the result is that a restriction is applicable).

Thus, when the second operation request is received, the restriction executing unit 155 determines whether the current screen providing mode is Mirroring mode or Extension mode (in other words, whether the screen information generating unit 156 is operating in Mirroring mode or Extension mode). Furthermore, the restriction executing unit 155 selects either the operation restriction information for the Mirroring mode or the operation restriction information for the Extension mode, based on the result of the mode determination, and executes the operation restriction based on the selected operation restriction information. This allows flexible operation restrictions to be applied to operations from the external terminal 110 based on the screen providing mode, depending on the situation (or in other words, according to whether the screen represented by the screen information generated for the request source external terminal 110 of the second operation request is the same as the screen displayed on the display unit 162). Note that the screen providing mode may be common to all external terminals 110 or independent for each external terminal 110.

According to the process depicted in FIG. 6, the restriction executing unit 155 executes the operation restriction without vehicle information based on the restriction information for the Mirroring mode when the current screen providing mode is the Mirroring mode. This avoids the case where, while traveling, restrictions that should apply only to the information processing device 100 (restrictions that should apply only to operations via the user interface 103) are applied to all external terminals 110 communicating with the information processing device 100. In addition, since vehicle information does not need to be referenced, a reduction in processing load can be expected as compared to the Extension mode.

Furthermore, with the process depicted in FIG. 6, when the current screen providing mode is Extension mode, the restriction executing unit 155 executes the operation restriction based on the operation restriction information for Extension mode and the vehicle information. When Extension mode is used, the screen displayed on the external terminal 110 is different from the screen displayed on the display unit 162, so it is possible that operations that should be restricted during travel may be performed from the external terminal 110 through a different screen. However, if the vehicle information determines that the vehicle is in motion, these operations can be restricted. Furthermore, if there are operations from the external terminal 110 that should be restricted during travel, a possible method is to generate for the external terminal 110 the screen information on a screen where these operations are not performed. However, even without the ability to generate such screens, it is possible to prevent the external terminal 110 from performing operations that should be restricted during travel. Note that the travel restriction information 121 may define, for each external terminal 110, the operations that are restricted during travel when Extension mode is used.

The present invention is not limited to the abovementioned embodiment and includes various modified examples. For example, while the abovementioned embodiment has been described in detail in order to describe the present invention in an easy-to-understand manner, the present invention is not necessarily limited to configurations with all the described configurations. Moreover, not only the deletion of such configurations, but also the replacement or addition of configurations is possible. For example, in the above embodiment, an example of an information processing device 100 mounted on a vehicle 50 was described, but the present invention is not restricted to information processing devices as in-vehicle devices.

Identification by the external terminal identifying unit may include determining whether the external terminal that is the request source of the second operation request is an external terminal in the driver's seat. This determination may be based on images captured from a camera 115 or by other methods. The restriction executing unit 155 may execute the operation restriction based on the travel restriction information 121 and the operation restriction information 122 when the request source external terminal 110 is the external terminal 110 in the driver's seat of the vehicle 50. On the other hand, the restriction executing unit may execute the operation restriction based on the operation restriction information 122 when the request source external terminal 110 is an external terminal 110 other than an external terminal in the driver's seat of the vehicle 50. The external terminal 110 can be operated from the driver's seat, but these operations from this external terminal 110 can be subject to travel restrictions.

### DESCRIPTION OF REFERENCE NUMERALS

50. Vehicle, 20. Information processing device, 21. Touch panel display, 22. Processing unit 23. Storage unit, 31. Navigation function unit, 32. Contents provider function unit, 33. Instrument panel function unit

1. An information processing device having a communication interface connected to an external terminal and a user interface that receives operation requests from a user, comprising:
a first operation request receiving unit that receives an operation request from the user via the user interface;
a second operation request receiving unit that receives an operation request from the external terminal via the communication interface;
a storage unit that stores restriction information for applying an operation restriction to a function performed by the information processing device to the first operation request received by the first operation request receiving unit or the second operation request received by the second operation request receiving unit;
an external terminal identifying unit that identifies the external terminal from which the second operation request is made based on the second operation request; and
a restriction executing unit that executes the operation restriction based on the restriction information when the first operation request is received, and executes the operation restriction based on the identification result of the external terminal identifying unit and the restriction information when the second operation request is received.

2. The information processing device according to claim 1, further comprising:
a screen information generating unit that generates screen information for the screen displayed on the external terminal; and
a screen information transmitting unit that transmits the screen information to the external terminal,
wherein
the user interface includes a display unit,
a first mode is to generate screen information of the same screen as that displayed on the display unit, for the external terminal, and a second mode is to generate screen information of a screen different from the screen displayed on the display unit, for the external terminal,
the second restriction information when the second operation request is received is the second restriction information for the first mode and the second restriction information for the second mode,
when the second operation request is received, the restriction executing unit
performs mode determination to determine whether the screen information generating unit is operating in the first mode or the second mode, and
based on the result of the mode determination, the system selects either the second restriction information for the first mode or the second restriction information for the second mode, and executes the operation restriction based on the selected second restriction information.

3. The information processing device according to claim 1, further comprising:
a vehicle information acquiring unit that acquires vehicle information including vehicle speed information,
wherein
the restriction information is
first restriction information for applying an operation restriction to the first operation request or second operation request when the vehicle is determined to be in motion based on the vehicle information, and
second restriction information for applying an operation restriction to an operation request received by the second operation request receiving unit.

4. The information processing device according to claim 3, wherein
when the screen information generating unit is operating in the first mode, the restriction executing unit executes the operation restriction without the vehicle information based on the second restriction information for the first mode.

5. The information processing device according to claim 3, wherein
when the screen information generating unit is operating in the second mode, the restriction executing unit executes the operation restriction based on the vehicle information and the second restriction information for the first mode.

6. The information processing device according to claim 3, wherein
identification by the external terminal identifying unit includes determining whether the external terminal that is the request source of the second operation request is an external terminal in the driver's seat, and
the restriction executing unit
executes the operation restriction based on the first restriction information and the second restriction information if the external terminal is an external terminal in the driver's seat of the vehicle, and
executes the operation restriction based on the second restriction information when the external terminal is an external terminal in a seat other than the driver's seat of the vehicle.

7. A non-transient storage medium having computer readable instruction stored thereon, when executed by a processor of an information processing device, configures the processor to perform:
a receiving step of receiving a first operation request as an operation request via a user interface from a user or a second operation request as an operation request from an external terminal via a communication interface,
an identifying step of identifying the external terminal that is a request source of the second operation request based on the second operation request, when the received operation request is the second operation request; and
an executing step of an operation restriction based on the restriction information when the first operation request is received, or the operation restriction based on the result of the identification and the restriction information when the second operation request is received.
